(19) United States
(12) Patent Application Publication
(10) Pub. No.: US 2010/0287804 A1
(43) Pub. Date: Nov. 18, 2010

(54) ADVERTISING DISPLAY ASSEMBLY

(76) Inventors: Brian K. Jones, Cary, NC (US); Teresa E. Jones, Cary, NC (US)

Correspondence Address: OLIVE LAW GROUP, PLLC, 130 EDINBURGH SOUTH DRIVE, SUITE 107, CARY, NC, 27511, US

(21) Appl. No.: 12/699,966

(22) Filed: Feb. 4, 2010

Related U.S. Application Data
(60) Provisional application No. 61/216,119, filed on May 14, 2009.

(51) Int. Cl. G09F 15/00; G09F 7/00; G09F 15/02

(52) U.S. Cl. 40/606.1

(57) ABSTRACT

An advertising display assembly is provided. The advertising display assembly includes a sleeve having a first panel and a spaced-apart second panel that defines a space therebetween for receiving a graphical display sheet. The advertising display assembly also includes an attachment device for attaching the sleeve to a proximal structure and a seal carried on the first panel for providing access into the space for receiving the graphical display sheet.

### CROSS REFERENCE TO RELATED APPLICATIONS

This application claims priority to U.S. Provisional Patent Application No. 61/216,119 filed on May 14, 2009, the contents and subject matter of which are hereby incorporated.

### TECHNICAL FIELD

The presently disclosed subject matter is directed towards an advertising display assembly, and more particularly towards an advertising display assembly for use with real estate and related advertisements.

### BACKGROUND

Real estate agents and brokers commonly use a brochure box or flyer tube to dispense brochures having information and pictures relating to a home for sale. The brochure box is usually fastened to a sign that is proximate to the home and conveniently accessible to potential homebuyers. Brochures are manually supplied to the brochure box and interested persons are able to access and review the brochures and the information contained thereon. It is not uncommon for brochure boxes to quickly and unexpectedly run out of brochures. Accordingly, the real estate agent or broker must resupply the brochures when the brochure box is empty. However, providing the additional supply and refilling of brochures is often not performed expeditiously, thereby resulting in frustration to the home seller and even missed sales opportunities. In addition, during storms or inclement weather, brochures may become wet or water logged. Many brochures are expensive color brochures, and the wet or water logged brochures must be replaced, resulting in increased costs and overhead for real estate agents. In addition, many potential homebuyers are mostly concerned with the listing price of the home and only take a brochure to determine the listing price, yet the potential homebuyers will rarely replace the brochure in the brochure box if the home price is not within their acceptable price ranges. This also results in a waste of brochures. Furthermore, conventional advertising display assemblies are not always at eye level with an interested person. Many homebuyers will drive their automobile in home developments that they are interested in and reach through an opened automobile window to grab for a brochure. Due to varying heights of automobiles, sometimes these brochures are not readily or easily reachable.

Accordingly, there remains a need for an advertising display assembly that addresses these and other disadvantages associated with conventional advertising display assemblies.

### SUMMARY

According to one aspect of the disclosed subject matter, an advertising display assembly is provided. The advertising display assembly includes a sleeve having a first panel and a spaced-apart second panel that defines a space therebetween for receiving a graphical display sheet, an attachment device for attaching the sleeve to a proximal structure, and a seal carried on the first panel for providing access into the space for receiving the graphical display sheet.

According to another aspect of the disclosed subject matter, the attachment device includes a reel and line assembly for varying the length of the attachment device.

According to another aspect of the disclosed subject matter, the sleeve defines an aperture for receiving the attachment device.

According to another aspect of the disclosed subject matter, the attachment device further includes a ring attaching the reel and line assembly to the aperture.

According to another aspect of the disclosed subject matter, the attachment device further includes a hook for attaching to the proximal structure.

According to another aspect of the disclosed subject matter, the advertising display assembly also includes a graphical display sheet in the space between the first and second panels.

According to another aspect of the disclosed subject matter, the sleeve defines a first end and a second end, and the attachment device is attached at the first end, and further wherein the seal is a zipper that is carried on the first panel at a medial position between the first and second ends.

According to another aspect of the disclosed subject matter, the zipper includes a first track and a mutually engageable second track, and whereby engagement of the first track and the second track closes the zipper.

According to another aspect of the disclosed subject matter, the first panel is divided by the zipper into a first portion at the first end of the sleeve and a second portion at the second end of the sleeve.

According to another aspect of the disclosed subject matter, the first portion carries the first track and the second portion carries the second track, and further wherein the first track is positioned at an outer periphery of the first panel and the second track is positioned at an inner periphery of the first panel facing the second panel such that the first track is positioned outside of the second track relative to the space defined between the first and second panels to thereby define a water runoff overhang.

According to another aspect of the disclosed subject matter, the advertising display assembly also includes advertising indicia on the sleeve.

According to another aspect of the disclosed subject matter, an advertising display assembly is provided that includes a sleeve having a first panel and a spaced-apart second panel that defines a space therebetween for receiving a graphical display sheet. An attachment device is provided that includes a reel and line assembly carried by the sleeve for attaching the sleeve to a proximal structure. A zipper is carried on the first panel at a medial location between respective first and second ends of the first panel for providing access into the space for receiving the graphical display sheet. The zipper includes a first track and a mutually engageable second track. When the first track and the second track are engaged, a water runoff overhang is defined to maintain a water tight seal in the space for receiving the graphical display sheet.

According to another aspect of the disclosed subject matter, the advertising display assembly includes a first graphical display sheet and a second graphical display sheet in the space between opposed panels. The second graphical display sheet is placed in a direction opposite the direction than that of the first graphical display sheet such that graphics can be viewed through either of the first or second panels.

According to another aspect of the disclosed subject matter, an advertising display assembly is provided and includes a longitudinally extending sleeve having a first panel and a spaced-apart second panel that defines a space therebetween for receiving a graphical display sheet. The longitudinally extending sleeve also has respective first and second longitudinal ends. An attachment device is provided and includes a reel and line assembly attached to a ring that is carried by the sleeve at the first longitudinal end for attaching the sleeve to a proximal structure. A laterally extending zipper is carried on the first panel at a medial location between respective first and second longitudinal ends of the first panel for providing access into the space for receiving the graphical display sheet. The zipper includes a first track carried by a first portion of the first panel that is defined between the zipper and the first longitudinal end and also includes a mutually engageable second track carried by a second portion of the first panel that is defined between the zipper and the second longitudinal end. The first track is positioned at an outer periphery of the first panel and the second track is positioned at an inner periphery of the first panel such that when the first track and the second track are engaged, a water runoff overhang is defined by the first track to maintain a water tight seal in the space for receiving the graphical display sheet.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Further, the claimed subject matter is not limited to implementations that solve any or all disadvantages noted in any part of this disclosure.

### BRIEF DESCRIPTION OF THE DRAWINGS

The foregoing summary, as well as the following detailed description of preferred embodiments, is better understood when read in conjunction with the appended drawings. For the purposes of illustration, there is shown in the drawings exemplary embodiments; however, the presently disclosed subject matter is not limited to the specific methods and instrumentalities disclosed. In the drawings:

FIG. 1 is a front view of an advertising display assembly according to one embodiment of the presently disclosed subject matter;

FIG. 2 is a cross sectional view of a sleeve and zipper of the advertising display assembly according to one embodiment of the presently disclosed subject matter; and

FIG. 3 is a perspective environmental view of the advertising display assembly affixed to a proximate structure according to one embodiment of the presently disclosed subject matter.

### DETAILED DESCRIPTION

The presently disclosed subject matter now will be described more fully hereinafter with reference to the accompanying drawings, in which some, but not all embodiments are shown. Indeed, this invention may be embodied in many different forms and should not be construed as limited to the embodiments set forth herein; rather, these embodiments are provided so that this disclosure will satisfy applicable legal requirements. Like numbers refer to like elements throughout.

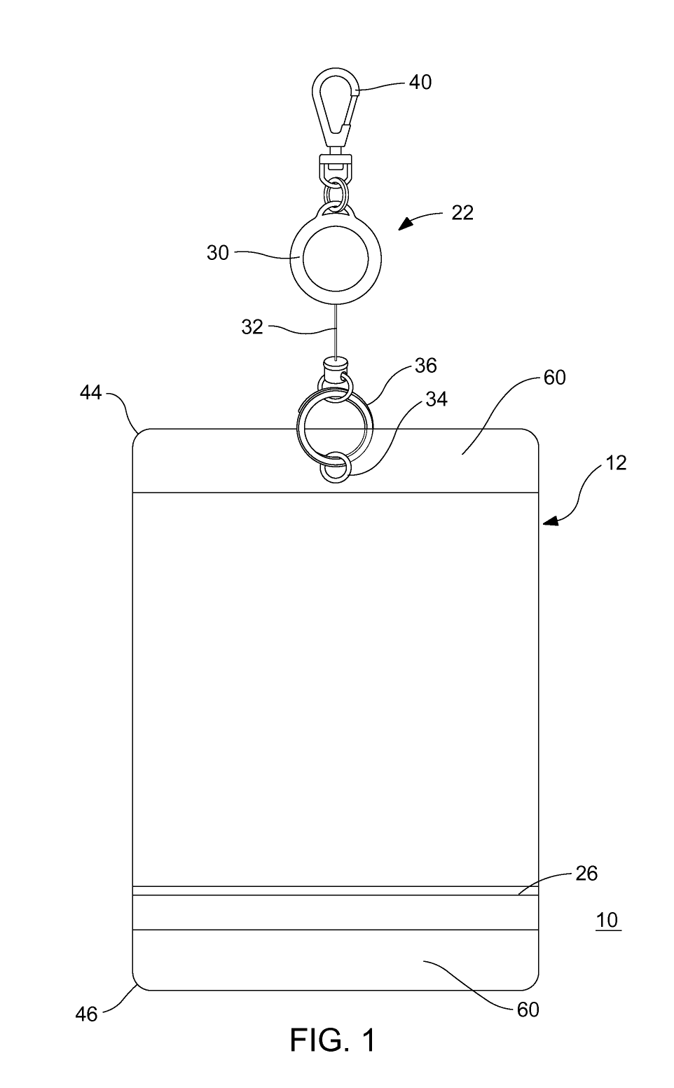

FIG. 1 illustrates an advertising display assembly that is generally designated as 10 throughout the drawings. The advertising display assembly 10 includes a sleeve 12 and an attachment device 22 for attaching the sleeve 12 to a proximal structure. The sleeve 12 includes a seal that is shown as a zipper 26 that allows access into the sleeve 12 for manually inserting a graphical display sheet. The attachment device 22 includes a reel assembly 30 and a cooperative line assembly 32. The reel assembly 30 may be retractable such that the line assembly 32 always returns to a predetermined position within the reel assembly 30 once the line assembly 32 is no longer being handled by an interested person. A ring 36 may be provided for attaching the line assembly 32 to an aperture 34 defined in the panel 12. In some embodiments, the aperture 34 may include an eyelet ring around the periphery of the aperture 34. A hook 40 is also attached to the reel assembly 30 for attaching to a proximal structure. The sleeve 12 has a first end 44 and a second end 46 defined on longitudinal ends of the sleeve 12. The sleeve 12 may also include advertising indicia defined in pockets 60 on the sleeve 12.

The zipper 26 is medially positioned between the first end 44 and the second end 46, and in some embodiments, is positioned at about 1 inch from the advertising indicia defined in pockets 60 on the sleeve 12. In this manner, the seam lines defined at each pocket 60 on the sleeve 12 and the zipper 26 visually appear to all be seam lines to an interested person. Accordingly, interested persons may not realize that the zipper 26 provides access into the sleeve 12, instead believing that the zipper is another seam line, and therefore interested persons may be deterred from attempting to take a graphical display sheet from within the sleeve 12.

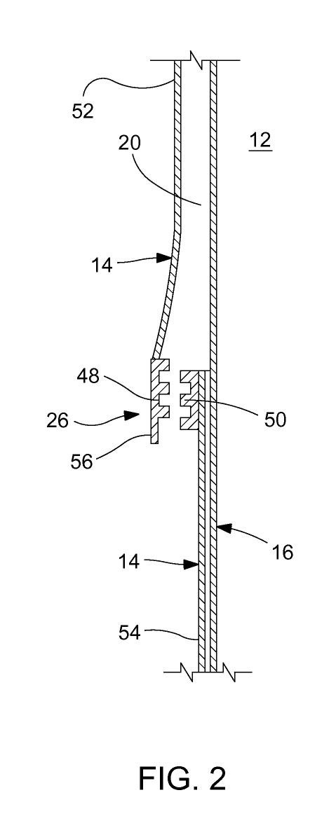

FIG. 2 illustrates a cross sectional view of the sleeve 12. The sleeve 12 includes a first panel 14 that carries the zipper 26 and a second panel 16 that cooperatively define a space 20 therebetween that can receive a graphical display sheet. The zipper 26 includes a first track 48 and a mutually engageable second track 50. The first track 48 and the second track 50 cooperatively engage one another to form a seal protecting the space 20. The first track 48 is carried on the first panel 14 at a first portion 52 that is defined between the zipper 26 and the first end 44 of the sleeve 12. The second track 50 is carried on the first panel 14 at a second portion 54 that is defined between the zipper 26 and the second end 46 of the sleeve 12. The first track 48 includes a flange 56 that creates a water seal overhang such that water or other liquids running down the first panel 14 will run off away from the zipper 26.

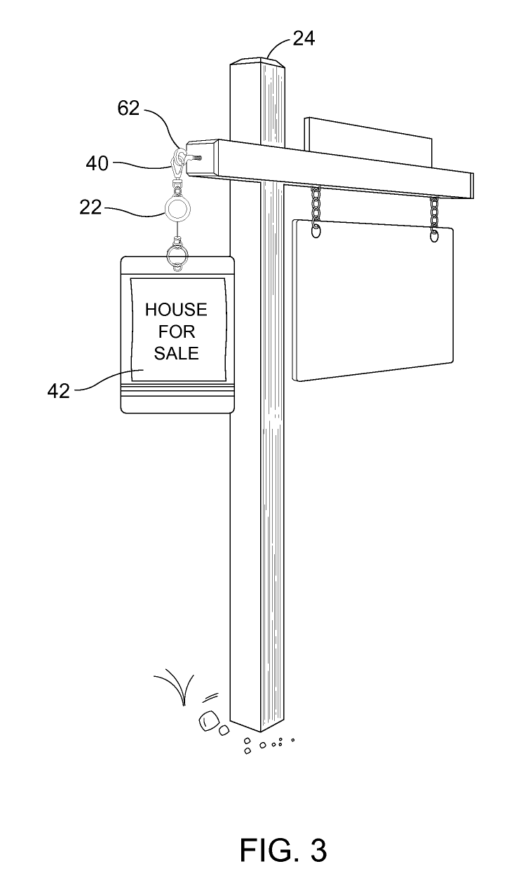

FIG. 3 illustrates the advertising display assembly 10 fastened to a proximal structure 24. In the embodiment shown in FIG. 3, the hook 40 is fastened to an eye hook 62 carried by the proximal structure 24. In other embodiments, the advertising display assembly 10 may be fastened to any appropriate feature of the proximal structure 24. The advertising display assembly 10 includes a graphical display sheet 42 positioned within the space 20 of the sleeve 12. The graphical display sheet 42 may have printing on both sides of the display sheet 42 such that a viewer may view advertising information on both sides of the advertising display assembly 10. In other embodiments, two graphical display sheets 42 may be inserted into the space 20 of the sleeve in oppositely facing directions.

The sleeve 12 is preferably made of durable grade vinyl, and in some embodiments, may be made of a 12 millimeter marine grade vinyl. In one embodiment, the sleeve 12 may be made of a marine grade vinyl comprising polyvinyl chloride of 12 micrometers in width. In other embodiments, the sleeve 12 may include an ultraviolet protective coating. In some embodiments, the sleeve 12 may be 12 to 14 inches in length and 8 to 10 inches in width.

The advantages associated with the subject matter of the advertising display assembly 10 are apparent. The advertising display assembly 10 may be used in conjunction with brochure boxes or flyer tubes and with the presence of the advertising display assembly 10, interested persons can view the information provided on the graphical display sheet 42. In some embodiments, the graphical display sheet 42 may be a real estate brochure matching the brochure found in the brochure boxes or flyer tubes. In addition, brochure waste is reduced as many interested persons may find the information that they seek on the graphical display sheet 42 and opt not to take a brochure. Additionally, the advertising display assembly 10 forms a water tight seal so that even during and after inclement weather, the graphical display sheet 42 should remain dry and viewable. Also, the advertising display assembly 10 is easily reachable by a person in an automobile and the reel 30 and line assembly 32 allows the interested person to pull the graphical display sheet 42 into view and then release the advertising display assembly 10 into its predetermined position.

While the embodiments have been described in connection with the preferred embodiments of the various figures, it is to be understood that other similar embodiments may be used or modifications and additions may be made to the described embodiment for performing the same function without deviating therefrom. Therefore, the disclosed embodiments should not be limited to any single embodiment, but rather should be construed in breadth and scope in accordance with the appended claims.

What is claimed:

1. An advertising display assembly comprising:
a sleeve having a first panel and a spaced-apart second panel that defines a space therebetween for receiving a graphical display sheet;
an attachment device for attaching the sleeve to a proximal structure; and
a seal carried on the first panel for providing access into the space for receiving the graphical display sheet.

2. The advertising display assembly according to claim 1, wherein the attachment device comprises a reel and line assembly for varying the length of the attachment device.

3. The advertising display assembly according to claim 2, wherein the sleeve defines an aperture for receiving the attachment device.

4. The advertising display assembly according to claim 3, wherein the attachment device further comprises a ring attaching the reel and line assembly to the aperture.

5. The advertising display assembly according to claim 4, wherein the attachment device further comprises a hook for attaching to the proximal structure.

6. The advertising display assembly according to claim 1, further including a graphical display sheet in the space between the first and second panels.

7. The advertising display assembly according to claim 1, wherein the sleeve defines a first end and a second end, and the attachment device is attached at the first end, and further wherein the seal is a zipper that is carried on the first panel at a medial position between the first and second ends.

8. The advertising display assembly according to claim 7, wherein the zipper comprises a first track and a mutually engageable second track, and whereby engagement of the first track and the second track closes the zipper.

9. The advertising display assembly according to claim 8, wherein the first panel is divided by the zipper into a first portion at the first end of the sleeve and a second portion at the second end of the sleeve.

10. The advertising display assembly according to claim 9, wherein the first portion carries the first track and the second portion carries the second track, and further wherein the first track is positioned at an outer periphery of the first panel and the second track is positioned at an inner periphery of the first panel facing the second panel such that the first track is positioned outside of the second track relative to the space defined between the first and second panels to thereby define a water runoff overhang.

11. The advertising display assembly according to claim 1, further including advertising indicia on the sleeve.

12. An advertising display assembly comprising:
a sleeve having a first panel and a spaced-apart second panel that defines a space therebetween for receiving a graphical display sheet;
an attachment device comprising a reel and line assembly carried by the sleeve for attaching the sleeve to a proximal structure; and
a zipper carried on the first panel at a medial location between respective first and second ends of the first panel for providing access into the space for receiving the graphical display sheet, the zipper comprising a first track and a mutually engageable second track;
wherein when the first track and the second track are engaged, a water runoff overhang is defined to maintain a water tight seal in the space for receiving the graphical display sheet.

13. The advertising display assembly according to claim 12, wherein the sleeve defines an aperture for receiving the attachment device.

14. The advertising display assembly according to claim 13, wherein the attachment device further comprises a ring attaching the reel and line assembly to the aperture.

15. The advertising display assembly according to claim 14, wherein the attachment device further comprises a hook for attaching to the proximal structure.

16. The advertising display assembly according to claim 12, further including a first graphical display sheet in the space between the first and second panels.

17. The advertising display assembly according to claim 16, further including a second graphical display sheet in the space between opposed panels, wherein the second graphical display sheet is placed in a direction opposite the direction than that of the first graphical display sheet such that graphics can be viewed through either of the first or second panels.

18. The advertising display assembly according to claim 12, further including advertising indicia on the sleeve.

19. An advertising display assembly comprising:
a longitudinally extending sleeve having a first panel and a spaced-apart second panel that defines a space therebetween for receiving a graphical display sheet, the longitudinally extending sleeve also having respective first and second longitudinal ends;
an attachment device comprising a reel and line assembly attached to a ring that is carried by the sleeve at the first longitudinal end for attaching the sleeve to a proximal structure; and
a laterally extending zipper carried on the first panel at a medial location between respective first and second longitudinal ends of the first panel for providing access into the space for receiving the graphical display sheet, the zipper comprising a first track carried by a first portion of the first panel that is defined between the zipper and the first longitudinal end and a mutually engageable second track carried by a second portion of the first panel that is defined between the zipper and the second longitudinal end;
wherein the first track is positioned at an outer periphery of the first panel and the second track is positioned at an inner periphery of the first panel such that when the first track and the second track are engaged, a water runoff overhang is defined by the first track to maintain a water tight seal in the space for receiving the graphical display sheet.
